(19) United States
(12) Patent Application Publication
(10) Pub. No.: US 2007/0288278 A1
(43) Pub. Date: Dec. 13, 2007

(54) METHOD AND SYSTEM FOR AUTOMATICALLY SCHEDULING AND MANAGING AGENDAS FOR PRESENTATION-STYLE MEETINGS

(75) Inventors: Geoffrey David Alexander, Chapel Hill, NC (US); Mohamad R. Salahshoor, Raleigh, NC (US)

Correspondence Address: GERALD J. IWANEJKO, JR., 229 HICKORY HILL DRIVE, VOLANT, PA, 16156, US

(73) Assignee: INTERNATIONAL BUSINESS MACHINES CORPORATION, Armonk, NY (US)

(21) Appl. No.: 11/309,048

(22) Filed: Jun. 13, 2006

(51) Int. Cl. G05B 19/418; G06F 9/46

(52) U.S. Cl. 705/8

(57) ABSTRACT

An invention is disclosed for automated scheduling and management of meetings. Specifically, a method and system are disclosed for using a computer software application to automatically schedule and manage agendas for presentation-style meetings, through the operation of programmed rules designed to optimize presentation schedules by acting upon criteria provided by meeting participants so as to resolve any conflicts arising amongst them.

### TECHNICAL FIELD

This invention relates generally to computerized scheduling of meetings, and specifically to a method and system for using a computer software application to automatically schedule and manage agendas for presentation-style meetings, through the operation of rules designed to optimize potential schedules based upon criteria provided by meeting participants.

### BACKGROUND

Today many individuals and businesses rely upon electronic calendar computer software applications to schedule meetings. Such applications allow a user to coordinate his or her individual daily schedule for the purpose of arranging meetings with other user(s) of the software scheduling application. A user may input desired criteria in order to schedule a meeting, such as a request for attendance by other individual(s) and one or more proposed dates, times and durations for the intended meeting. The scheduling application will then access the electronic calendars of all potential attendees using the provided criteria to determine whether or not each of them will be available to attend the meeting. If a common proposed meeting date, time and duration has been found for all intended participants, the scheduling application places the meeting schedule on the individual electronic calendar of each participant. However, if the electronic calendar of any potential attendee shows that he or she is unavailable because of a conflicting event on the proposed date and time of the meeting, the scheduling application then advises the user(s) that the proposed meeting cannot be scheduled as requested.

The use of intelligent software programs (or “agents”) to automate the scheduling of meetings is known; including those described in Agent-Based Approach to Dynamic Meeting Scheduling Problems authored by Ahlem Ben Hassine, Xavier Defago and Tu Bao Ho; Agent-Based Meeting Scheduling: A Design and Implementation by N. R. Jennings and A. J. Jackson; CMRadar: A Personal Assistant Agent for Calendar Management by Pragnesh Jay Modi, Manuela Veloso, Stephen F. Smith and Jean Oh; Mechanism Design for Multi-Agent Meeting Scheduling Including Time Preferences, Availability and Value of Presence by Elisabeth Crawford and Manuela Veloso; and An Automated Distributed Meeting Scheduler by Sandip Sen (the teachings of which are all incorporated by reference as if fully set forth herein). However, such known methods are based upon scheduling techniques which operate on the assumption that participants are required to attend the entire meeting; including the teachings set forth in U.S. Pat. Nos. 6,781,920 & 5,124,912 and in U.S. Patent Application Publication No. 2002/0184063 (the disclosures of which are also all incorporated by reference as if fully set forth herein).

In contrast to all of these teachings, there are a number of situations in which selected participants are required to attend only portion(s) of the same meeting (referred to as “presentation-style” meetings); including those in which a number of different presentations are given by more than one individual or group; “review board” meetings in which a number of different ideas are presented for approval or other form of evaluation; and “status” meetings in which a number of individuals or groups present status on different issues to an individual or committee. (The participant(s) who provide information at presentation-style meetings are referred to as “presenters” and the participant(s) receiving the information are referred to as “audience members”.) Presenters are often required to attend a presentation-style meeting only during their presentation time(s), while audience members are often required to attend the entire meeting.

Scheduling attendance for participants at such presentation-style meetings adds a level of complexity not adequately handled by known automated meeting scheduling techniques. For example, the same presenter(s) may be scheduled to give multiple presentations during a single meeting. In such cases, it is sometimes advantageous to schedule different presentations given by the same presenter(s) in contiguous period(s) of time instead of at separate times. In addition, the meeting schedule may require that certain presentations occur in a specified order. Additional complexity arises when a presenter needs to reschedule one or more presentation times after the meeting agenda has been finalized. This invention provides a solution to these problems by using a computer software application to automatically schedule and manage agendas for presentation-style meetings, through the operation of rules designed to optimize potential schedules based upon criteria provided by meeting participants.

### SUMMARY OF THE INVENTION

An invention is disclosed for using a computer software application to automatically schedule and manage agendas for presentation-style meetings, through the operation of programmed rules designed to optimize presentation schedules by acting upon criteria provided by meeting participants so as to resolve any conflicts arising amongst them.

The invention uses intelligent software agents to automate the scheduling of “presentation-style” meetings, by providing a “scheduling agent” that generates one or more possible “candidate agendas” for the meeting based upon user-specified criteria or constraints. The scheduling agent then sends the candidate agendas (or relevant portions thereof) to the meeting participants, with a request for each participant to respond with a list of preferences selected from the candidate agendas. The scheduling agent then analyzes the responses of the meeting participants using standard optimization techniques to determine one or more “optimal agenda(s)” for ordering the timing and sequence of presentations given in the meeting. A “calendaring agent” then automatically updates the calendars of each of the meeting participants with the optimal agenda(s), or it optionally sends a confirmation request seeking an acceptance of the meeting invitation from a participant before updating his or her calendar with the agenda(s). The invention can be used as part of a desktop or on-line meeting scheduling or calendaring service such as Microsoft Outlook®, Novell GroupWise®, Oracle® Calendar or Sun Java System® Calendar Server.

It is therefore an object of the present invention to overcome the disadvantages of the prior art by providing a method and system for using a computer software application to automatically schedule and manage agendas for presentation-style meetings, through the operation of programmed rules designed to optimize presentation schedules by acting upon criteria provided by meeting participants so as to resolve any conflicts arising amongst them.

It is another object of the present invention to overcome the disadvantages of the prior art by providing an intelligent software agent for automating the scheduling of presentation-style meetings, through use of a scheduling agent that generates one or more possible candidate agendas for the meeting based upon user-specified criteria or constraints, with a request for each participant to respond with a list of preferred agenda(s) selected from the candidate agendas, in order to determine one or more optimal agenda(s) for ordering the timing and sequence of presentations given in the meeting.

It is another object of the present invention to overcome the disadvantages of the prior art by providing an intelligent software agent for automating the scheduling of presentation-style meetings, through use of a calendaring agent that automatically updates the calendars for each of the meeting participants with the optimal agenda(s) selected for the meeting, or optionally sends a confirmation request seeking an acceptance of the meeting invitation from a participant before updating his or her calendar with the agenda(s).

The subject matter which is regarded as the invention is particularly pointed out and distinctly claimed in the concluding portion of the specification. The invention, however, together with further objects and advantages thereof, may best be understood by reference to the following description taken in conjunction with the accompanying drawings.

### BRIEF DESCRIPTION OF THE DETAILED DRAWINGS

FIG. 1 is an illustration of the electronic calendar computer software scheduling application of the present invention.

### DETAILED DESCRIPTION OF THE PREFERRED EMBODIMENTS

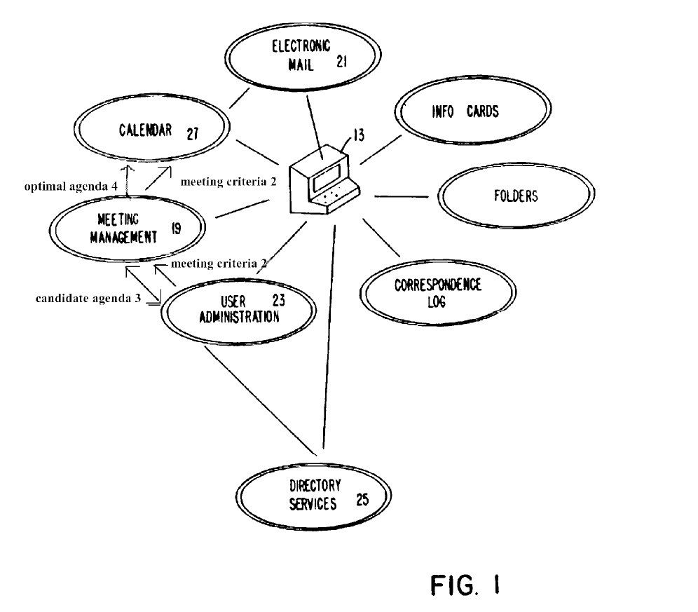

FIG. 1 illustrates a computer software scheduling application 1 that allows a user 23 to maintain an electronic calendar 27 in order to coordinate his or her individual daily schedule using a personal computer workstation 13. The electronic calendar 27 for each user 23 can be accessed by other users on a computer network (such as a local area network (“LAN”) or a wide area network (“WAN”) or the Internet) through a network directory 25. The electronic calendar software scheduling application 1 allows a user 23 (such as a meeting scheduler) to schedule meetings among other users maintaining individual electronic calendars 27 on the computer network. Each individual electronic calendar 27 can accept criteria for meeting events 2, such as a meeting start date/time and/or stop time or duration on particular day(s), and details describing the topic(s), location(s) and/or attendee(s) of the meeting. The meeting event criteria 2 arises from information provided by a user 23 that may be input manually or retrieved from other records (such as electronic mail or notes or files or correspondence).

The scheduling application 1 can access the individual electronic calendars 27 of potential meeting attendees using the provided criteria 2 to determine whether or not each of them are available to attend. If a common proposed meeting date, time and duration has been found for all intended participants, the scheduling application places the meeting schedule on the individual electronic calendar of each participant. However, if the calendar of any potential attendee shows that he or she is unavailable because of a conflicting event on the proposed date and time of the meeting, the scheduling application advises the affected user(s) that the proposed meeting cannot be scheduled as requested.

In one preferred embodiment of the invention, the intelligent software “scheduling agent” 19 receives request(s) from a user 23 to schedule a “presentation-style” meeting, along with a description of meeting criteria 2; including a list of presentations along with the presenters and audience members participating in each presentation, and the start date/time and duration for each presentation. The scheduling agent 19 uses this information to generate one or more possible proposed (or “candidate”) agendas 3 based on the availability of each participant to attend a given presentation as well as on other possible criteria 2; such as scheduling different presentations given by the same presenter(s) in contiguous period(s) of time instead of at separate times, or scheduling certain presentations only during certain periods of time and/or on certain dates (for example 9:00 a.m.-5:00 p.m. Monday through Friday).

After generating one or more possible candidate agendas 3 for a meeting, the scheduling agent 19 sends them to each of the presenters and audience members or other users 23 who may be interested in the meeting schedule. Based on an affirmative response from all of the participants indicating their common availability for at least one of the presentation date(s) and time(s) proposed in a candidate agenda 3, the scheduling agent 19 chooses one or more “optimal agenda(s)” 4 ordering the sequence of presentation times for the meeting using standard optimization techniques (such as those disclosed in the prior art incorporated by reference herein) which are then sent to each of the meeting presenters and audience members, optionally with an invitation requesting confirmation of their attendance. An intelligent software “calendaring agent” 27 then automatically updates the individual electronic calendars of each of the meeting participants with the optimal agenda(s) 4, or it optionally sends a confirmation request seeking an acceptance of the meeting invitation from a participant before updating his or her calendar with the agenda(s). In the case that no possible agenda can be chosen due to one or more negative responses to each of the candidate agendas (indicating a lack of availability of one or more participants at each proposed date and time of a presentation) the scheduling agent notifies the meeting participants and other interested scheduler users of this discrepancy.

It may not always be possible for the scheduling agent 19 to satisfy all of the criteria 2 input by a user 23. An example is the situation where three different presentations are provided to the scheduling agent for the same meeting, requiring Presentation I to be conducted by Presenter A and Presenter B; while also requiring Presentation II to be conducted by Presenter B and Presenter C; and additionally requiring Presentation III to be conducted by Presenter A and Presenter C. In that case, there is no possible agenda that satisfies the rule for scheduling different presentations given by the same presenter(s) in contiguous time period(s). In cases where the scheduling agent is unable to generate a single agenda that satisfies all required criteria for a meeting, it will generate one or more agenda(s) that individually (or in combination) fulfill the greatest (and violate the smallest) number of rules possible. There are still other situations in which the scheduling agent may not be able to generate any possible agenda, as for example in the case of the unavailability of an essential presenter and/or audience member. In such cases, the scheduling agent can again notify the meeting participants and other interested scheduler users of the discrepancy.

A solution to the above problem is to allow the scheduling agent to act upon additional rules (such as “Presentation I must be conducted before Presentation II and Presentation II must be conducted before Presentation III”) in a way that optionally overrides those criteria creating the problem (such as requiring different presentations by the same presenter(s) to occur contiguously or holding the meeting during fixed time(s), i.e., between 9:00 a.m.-noon on Monday or Wednesday). Another possible solution is to allow the attendance of some nonessential participants to be optional; or requiring the attendance of only a minimum number of essential participants at a given presentation; or to allow some participants to attend only a certain subset (but not all) of the presentations; or to allow certain group presentations to be conducted by some (but not all) of the presenters for that presentation. Another solution is to allow the scheduling agent to choose the presentations to be scheduled only from a predefined list rather than receiving criteria input by a user. For example, in the case of a review board where individuals and groups submit items to be reviewed on an on-going basis, the scheduling agent can generate possible candidate agendas only from the list of items submitted for review, by choosing presentations on a “first-come first-serve” basis or by employing a more advanced prioritization scheme for choosing those presentations to be scheduled.

Another feature of the invention is the ability to manage a meeting agenda after it has been finalized. An example is the situation of a finalized agenda for a presentation-style meeting scheduled for 1:00-3:00 p.m. with the first presentation set for 1:00-1:15 p.m., where the first presenter subsequently informs the scheduling agent that he or she is no longer available from 1:00-2:00 p.m. on the scheduled meeting date. Upon receiving this information, the scheduling agent can check the availability of those presenters scheduled to conduct their presentations between 2:00-3:00 p.m. on that date, and send a “switch request” to any presenters that are available from 1:00-1:15 p.m. If the scheduling agent receives an affirmative response accepting the change, it will send an updated agenda to all presenters and audience members confirming the change. If the scheduling agent is unable to accommodate the change, it will again notify the meeting participants and other interested scheduler users of the discrepancy. Another example of managing a meeting agenda after it has been finalized arises from a presentation-style meeting generated from a list of review items as previously described, where one of the presenters or audience members informs the scheduling agent that he or she is no longer available to attend the meeting at the scheduled date(s) and time(s). The scheduling agent can search the list of scheduled review items for a replacement presentation, and when one is found it will generate a switch request as described previously. Upon receiving acceptance of the change, the scheduling agent will again generate an updated agenda confirming the change. If the scheduling agent is unable to find a replacement presentation, it will again notify the meeting participants and other interested scheduler users of the discrepancy.

While certain preferred features of the invention have been shown by way of illustration, many modifications and changes can be made that fall within the true spirit of the invention as embodied in the following claims, which are to be interpreted as broadly as the law permits to cover the full scope of the invention, including all equivalents thereto.

What is claimed is:

1. A computer system comprised of the following software components configured for scheduling and managing at least one agenda for a meeting involving multiple presentations:
(a). a scheduling agent configured for:
(i). generating one or more proposed agendas for the meeting based on user-specified criteria; and
(ii). sending the proposed agendas to each meeting participant for review with a request for a response to the proposed agendas; and
(iii). determining one or more optimal agendas for ordering the timing and sequence of each presentation given in the meeting based on the response of each participant to the proposed agendas;
(b). a calendaring agent configured for:
(i). automatically updating the calendar of each meeting participant with one or more optimal agendas selected for the meeting; or
(ii). sending a confirmation request seeking acceptance of a meeting invitation from a participant before updating the calendar of that participant with an agenda;
wherein the software components create a meeting agenda through use of one or more programmed rules that optimize presentation schedules by acting upon the criteria provided by meeting participants so as to resolve conflicts arising between them.

2. The computer system of claim 1 wherein one or more optimization rules are chosen from a group comprised of the following criteria:
(a). identification of the topics covered along with the participating presenters and audience members as well as the starting date and time and duration for each presentation; or
(b). scheduling different presentations given by the same presenter(s) in the same meeting at contiguous periods of time; or
(c). scheduling selected presentations to occur only during selected periods of time or on selected dates; or
(d). allowing the attendance of selected meeting participants to be optional; or
(e). requiring the attendance of only a minimum number of participants at selected presentations; or
(f). allowing selected participants to attend only a subset of all presentations given in a meeting; or
(g). allowing selected presentations to be conducted by a subset of all the presenters for that presentation; or
(h). selecting the presentations to be scheduled only from a predefined list rather than from other criteria input by a user.

3. The computer system of claim 1 wherein the scheduling agent resolves conflicts by generating one or more meeting agendas that fulfill the greatest possible number of optimization rules based on the user-specified criteria.

4. The computer system of claim 3 wherein the scheduling agent resolves a conflict by acting upon one or more optimization rules that override the criteria creating the conflict.

5. The computer system of claim 4 wherein the scheduling agent notifies the meeting participants of any conflict which cannot be resolved.

6. The computer system of claim 1 wherein the scheduling agent manages a meeting agenda by generating a request for changing the sequence of one or more presentations to accommodate the unavailability of a participant arising after a meeting agenda has been finalized.

7. A method of using a computer system comprised of the following software components configured for carrying out the following steps in scheduling and managing at least one agenda for a meeting involving multiple presentations:
(a). a scheduling agent configured for:
(i). generating one or more proposed agendas for the meeting based on user-specified criteria; and
(ii). sending the proposed agendas to each meeting participant for review with a request for a response to the proposed agendas; and
(iii). determining one or more optimal agendas for ordering the timing and sequence of each presentation given in the meeting based on the response of each participant to the proposed agendas;
(b). a calendaring agent configured for:
(i). automatically updating the calendar of each meeting participant with one or more optimal agendas selected for the meeting; or
(ii). sending a confirmation request seeking acceptance of a meeting invitation from a participant before updating the calendar of that participant with an agenda;
wherein the software components create a meeting agenda through use of one or more programmed rules that optimize presentation schedules by acting upon the criteria provided by meeting participants so as to resolve conflicts arising between them.

8. The method of claim 7 wherein one or more optimization rules are chosen from a group comprised of the following criteria:
(a). identification of the topics covered along with the participating presenters and audience members as well as the starting date and time and duration for each presentation; or
(b). scheduling different presentations given by the same presenter(s) in the same meeting at contiguous periods of time; or
(c). scheduling selected presentations to occur only during selected periods of time or on selected dates; or
(d). allowing the attendance of selected meeting participants to be optional; or
(e). requiring the attendance of only a minimum number of participants at selected presentations; or
(f). allowing selected participants to attend only a subset of all presentations given in a meeting; or
(g). allowing selected presentations to be conducted by a subset of all the presenters for that presentation; or
(h). selecting the presentations to be scheduled only from a predefined list rather than from other criteria input by a user.

9. The method of claim 7 wherein the scheduling agent resolves conflicts by generating one or more meeting agendas that fulfill the greatest possible number of optimization rules based on the user-specified criteria.

10. The method of claim 9 wherein the scheduling agent resolves a conflict by acting upon one or more optimization rules that override the criteria creating the conflict.

11. The method of claim 10 wherein the scheduling agent notifies the meeting participants of any conflict which cannot be resolved.

12. The method of claim 7 wherein the scheduling agent manages a meeting agenda by generating a request for changing the sequence of one or more presentations to accommodate the unavailability of a participant arising after a meeting agenda has been finalized.
